(19) United States
(12) Patent Application Publication
(10) Pub. No.: US 2026/0309506 A1
(43) Pub. Date: Oct. 8, 2026

(54) ROUTE CREATION DEVICE, VEHICLE, AND METHOD FOR ROUTE GENERATION

(71) Applicant: TOYOTA JIDOSHA KABUSHIKI KAISHA, Toyota-shi (JP)

(72) Inventors: Shuntaro TSUTSUMI, Nagoya-shi (JP); Yuki SATOMI, Tokyo-to (JP); Ryo MASUTANI, Toyota-shi (JP)

(73) Assignee: TOYOTA JIDOSHA KABUSHIKI KAISHA, Toyota-shi (JP)

(21) Appl. No.: 19/637,448

(22) Filed: Apr. 2, 2026

(30) Foreign Application Priority Data
Apr. 8, 2025 (JP) 2025-063745

(51) Int. Cl. G01C 21/34

(52) U.S. Cl. CPC G01C 21/3453

(57) ABSTRACT

A route generator estimates a possibility of incorrect travel in which a vehicle proceeds in a direction different from a direction set as a travel route among multiple directions at more than one of branch points included in the travel route from a current position to a destination. The route generator estimates a loss based on at least one of time, money, and comfort when traveling each of a plurality of candidate routes from the current position to the destination if the possibility of incorrect travel at more than one of the branch points is estimated to be higher than a predetermined incorrect travel threshold. The route generator selects a route with minimum estimated loss among the plurality of candidate routes as an optimal candidate route.

### FIELD

This disclosure relates to a route generator, a vehicle, and a method for route generation for generating a travel route of the vehicle.

### BACKGROUND

Efficient travel of the vehicle becomes possible by appropriately setting a travel route for a vehicle from its current position to a destination. Japanese Unexamined Patent Publication No. 2020-051780 discloses a travel route setting system that acquires a basic route that a vehicle is scheduled to travel and an extended route that adds waypoints to the basic route, obtains a loss by subtracting the travel cost of the basic route from the travel cost of the extended route, obtains a profit from passing through the waypoints, and determines whether to adopt the extended route based on a comparison of the profit and loss.

### SUMMARY

When actually traveling a route, incorrect travel may occur that the vehicle proceeds in the wrong direction at a branch in the route. If incorrect travel occurs, a new travel route to the destination is generated and followed, but the travel cost, such as the required time and toll road fees, may be greater than the original travel route.

It is an object of this disclosure to provide a route generator that can generate a travel route in consideration of the travel cost in the event of incorrect travel.

The following is a summary of the present disclosure.

(1) A route generator including:

an incorrect travel estimation unit that estimates a possibility of incorrect travel in which a vehicle proceeds in a direction different from a direction set as a travel route among multiple directions at more than one of branch points included in the travel route from a current position to a destination,

a loss estimation unit that estimates a loss based on at least one of time, money, and comfort when traveling each of a plurality of candidate routes from the current position to the destination if the possibility of incorrect travel at more than one of the branch points is estimated to be higher than a predetermined incorrect travel threshold, and

a route selection unit that selects a route with minimum estimated loss among the plurality of candidate routes as an optimal candidate route.

(2) The route generator according to (1), wherein the incorrect travel estimation unit estimates the possibility of incorrect travel based on at least one of map information including the incorrect travel rate for each of the multiple directions at each branch point and environmental information representing the travel environment of the vehicle.

(3) The route generator according to (2), wherein the incorrect travel estimation unit estimates that, the higher the incorrect travel rate for the direction set as the travel route at the branch point in the travel route contained in the map information, the greater the possibility of incorrect travel at that branch point in the travel route.

(4) The route generator according to (2) or (3), wherein

the environmental information includes a surrounding image representing a situation of a forward branch point located ahead of the vehicle, and

the incorrect travel estimation unit estimates that, the lower the detection confidence when detecting a forward feature by inputting the surrounding image into a machine learning model trained to detect a predetermined feature, the greater the possibility of incorrect travel at the forward branch point.

(5) The route generator according to any one of (2)-(4), wherein

the environmental information includes a positioning accuracy of the vehicle, and

the incorrect travel estimation unit estimates that at a branch point where the positioning accuracy is lower than a predetermined accuracy threshold among more than one of the branch points included in the travel route, the possibility of incorrect travel is higher than that with higher positioning accuracy than the predetermined accuracy threshold.

(6) A vehicle including a travel controller configured to controls the vehicle so as to travel in accordance with the optimal candidate route selected by the route generator according to any one of (1)-(5).

(7) A method for generating route including:

estimating a possibility of incorrect travel in which a vehicle proceeds in a direction different from a direction set as a travel route among multiple directions at more than one of branch points included in the travel route from a current position to a destination,

estimating a loss based on at least one of time, money, and comfort when traveling each of a plurality of candidate routes from the current position to the destination if the possibility of incorrect travel at more than one of the branch points is estimated to be higher than a predetermined incorrect travel threshold, and

selecting a route with minimum estimated loss among the plurality of candidate routes as an optimal candidate route.

The route generator according to the present disclosure can generate a travel route in consideration of the travel cost in the event of incorrect travel.

### BRIEF DESCRIPTION OF DRAWINGS

FIG. 1 schematically illustrates a route generation according to the present disclosure.

FIG. 2 schematically illustrates a configuration of a vehicle including the route generator.

FIG. 3 schematically illustrates a hardware of the route generator.

FIG. 4 is a functional block diagram of the processor included in the route generator.

FIG. 5 is a flowchart of a route generation process.

### DESCRIPTION OF EMBODIMENTS

A route generator that can generate a travel route in consideration of the travel cost in the event of incorrect travel will now be described in detail with reference to the attached drawings.

The route generator of present embodiment estimates a possibility of incorrect travel in which a vehicle proceeds in a direction different from a direction set as a travel route among multiple directions at more than one of branch points included in the travel route from a current position to a destination. If the possibility of incorrect travel at more than one of the branch points is estimated to be higher than a predetermined incorrect travel threshold, the route generator of present embodiment estimates the loss when traveling each of a plurality of candidate routes to from the current position the destination. The loss is estimated based on more than one of time, money, and comfort. The route generator of present embodiment selects a route with minimum estimated loss among the plurality of candidate routes as an optimal candidate route.

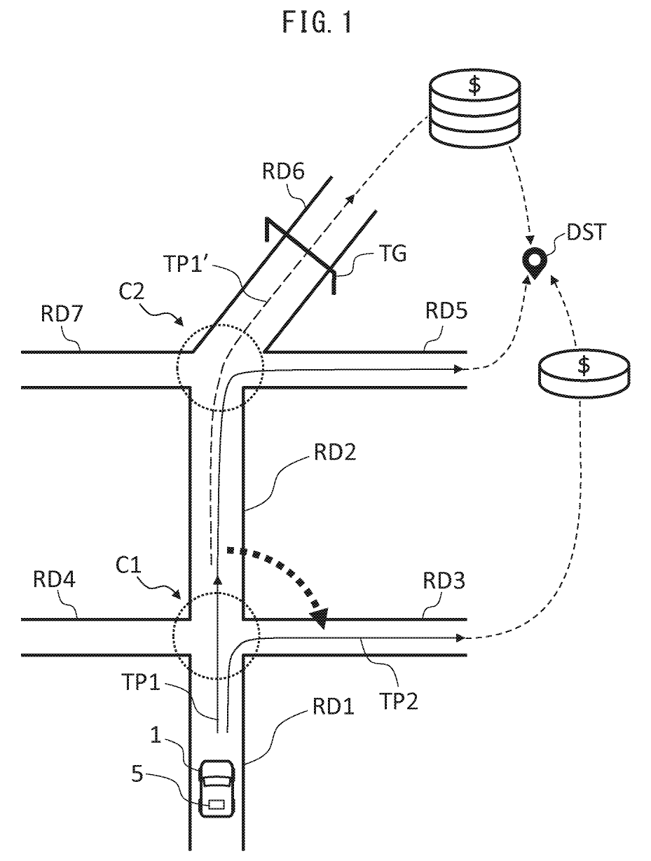

FIG. 1 schematically illustrates a route generation according to the present disclosure.

A vehicle 1 equipped with the route generator 5 of present embodiment is traveling according to the travel route TP1 toward the destination DST on the road RD1. The travel route TP1 is one route selected from multiple candidate routes to the destination DST from the current position according to predetermined selection criteria such as the shortest required time, the shortest travel distance, and the minimum energy cost. The travel route TP1 has intersections C1 and C2 ahead of the traveling direction of the vehicle 1. Intersections C1 and C2 are examples of branch points where the vehicle 1 can proceed in one of the multiple directions. Branch points may include, instead of or in addition to intersections, for example, branch points to branch lanes and lane change points to adjacent lanes.

At intersection C1, roads RD2-4 leading in different directions are connected. At intersection C2, roads RD5-7 leading in different directions are connected. The travel route TP1 is set to proceed straight through intersection C1 in the direction of road RD2 and turn right at intersection C2 in the direction of road RD5.

The route generator 5 estimates the possibility of incorrect travel in which the vehicle 1 proceeds in a direction different from the direction set as the travel route TP1 at the intersections included in the travel route TP1. For example, at intersection C1, the progress of vehicle 1 in the direction of road RD3 (right turn direction) or road RD4 (left turn direction), which is different from the direction of road RD2 (straight direction) set as the travel route TP1, corresponds to incorrect travel. Also, at intersection C2, the progress of vehicle 1 in the direction of road RD6 (right forward direction, travel route TP1’) or road RD7 (left turn direction), which is different from the direction of road RD5 (right turn direction) set as the travel route TP1, corresponds to incorrect travel. The route generator 5 estimates the possibility of incorrect travel for each of intersections C1 and C2, for example, as intersection C1: low possibility (e.g., 5%) and intersection C2: high possibility (e.g., 30%).

The route generator 5 compares the possibility of incorrect travel at the branch points included in the travel route TP1 with a predetermined incorrect travel threshold (e.g., 20%). In the example of FIG. 1, the possibility of incorrect travel at intersection C2 is 30%, which is higher than the incorrect travel threshold of 20%. In this case, the route generator 5 generates a plurality of candidate routes to the destination DST from the current position of vehicle 1 and estimates the loss when traveling each candidate route. The loss is estimated based on more than one of time, money, and comfort.

In the example of FIG. 1, the route generator 5 generates the travel route TP1-2 as a candidate route. For simplification of explanation, the possibility of incorrect travel at intersection C1 and the possibility of incorrect travel in the direction of road RD7 at intersection C2 are ignored.

In the loss when traveling the travel route TP1, the possibility of incorrect travel at intersection C2 is considered. That is, when traveling the travel route TP1, incorrect travel in the direction of road RD6 (travel route TP1’) occurs with a 30% probability at intersection C2. Road RD6 is, for example, a toll road with a toll gate TG, and a toll fee is incurred. Compared to traveling in the direction of road RD5 at intersection C2, the travel distance becomes longer, and the energy cost required for travel (cost corresponding to electricity and/or fuel consumed by travel) increases. That is, since a loss corresponding to the travel of road RD6 (e.g., 200) occurs with the probability of incorrect travel (e.g., 30%), the route generator 5 estimates the loss when traveling the travel route TP1 as, for example, 200×30%=60.

When traveling on route TP2, compared to traveling on route TP1 towards road RD5 at intersection C2, the travel distance becomes longer, and the energy cost required for travel (for example, 20) increases. Therefore, the route generator 5 estimates the loss when traveling on route TP2 to be, for example, 20.

The route generator 5 selects the route TP2, which has the minimum estimated loss among routes TP1-2, as the optimal candidate route.

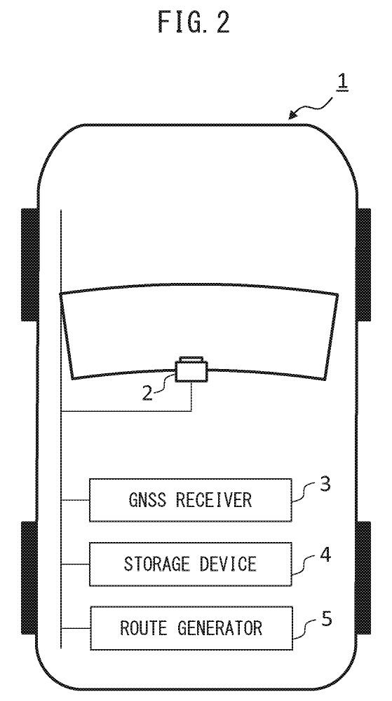

FIG. 2 schematically illustrates a configuration of vehicle 1.

Vehicle 1 in present embodiment is equipped with a surrounding camera 2, a GNSS receiver 3, a storage device 4, and a route generator 5.

The surrounding camera 2, GNSS receiver 3, storage device 4, and route generator 5 are communicatively connected via an in-vehicle network that complies with standards such as the Controller Area Network.

The surrounding camera 2 is an example of a sensor that generates surrounding data representing the surrounding conditions in front of vehicle 1 in a time series. The surrounding camera 2 consists of a two-dimensional detector made up of an array of photoelectric conversion elements sensitive to visible light, such as CCD or C-MOS, and an imaging optical system that forms an image of the area to be captured on the two-dimensional detector. The surrounding camera 2 is mounted, for example, at the upper front inside the vehicle cabin, facing the direction of travel of vehicle 1. The surrounding camera 2 captures the surrounding conditions in front of vehicle 1 through the windshield at predetermined shooting intervals (for example, 1/30 second to 1/10 second) and outputs the surrounding images representing the surrounding conditions as surrounding data to the route generator 5. The surrounding images may be output in video format.

Vehicle 1 may be equipped with more than one sensor, such as a LiDAR (Light Detection And Ranging) sensor, RADAR (Radio Detection And Ranging) sensor, millimeter-wave sensor, or ultrasonic sensor.

The GNSS receiver 3 is an example of a positioning sensor that receives GNSS signals from GNSS satellites at predetermined intervals via an unillustrated GNSS antenna and determines the self-position of vehicle 1 based on the received GNSS signals. GNSS signals can also be described as satellite radio signals used to identify the position of vehicle 1. The GNSS receiver 3 outputs a positioning signal representing the positioning result of vehicle 1's self-position based on GNSS signals to the route generator 5 via the in-vehicle network at predetermined intervals. The GNSS receiver 3 may also output positioning accuracy information indicating the positioning accuracy based on GNSS signals to the route generator 5 along with the positioning signal. Positioning accuracy can be determined based on factors such as the radio signal strength of GNSS signals, the number of GNSS satellites received, and the degradation conditions due to multipath.

The storage device 4 is an example of a vehicle storage device, which may include non-volatile semiconductor memory or a hard disk drive. The storage device 4 stores map information about specific geographical features present around the roads.

The map information stored in the storage device 4 includes information indicating the possible directions of travel at points (nodes) included in the roads. In addition, the map information includes information indicating the loss (cost) incurred by traveling the links connecting adjacent points (nodes). The loss may include more than one of toll fees, energy costs required for travel, travel time, and ease of travel. Furthermore, the map information may include the probability of incorrect travel for each of the multiple directions at each branch point where multiple directions are possible.

The map information stored in the storage device 4 may include the travel history of vehicle 1. In the travel history, the history of travel following the route generated by the route generator 5 and the history of travel due to route changes or manual driving by the driver may be distinguished.

The storage device 4 may store the probability of correct travel for each of the multiple directions at each branch point as map information instead of the probability of incorrect travel. The probability of incorrect travel is obtained by subtracting the probability of correct travel from 1.

The route generator 5 has a communication interface, memory, and processor, and is an ECU (Electronic Control Unit) that controls the operation of vehicle 1. The route generator 5 is implemented as a navigation device that presents travel routes to the driver of vehicle 1. The route generator 5 may also be implemented as a travel controller (not shown) that controls the travel of vehicle 1. The route generator 5, for example, acquires data from the surrounding camera 2 and selects the optimal candidate route for vehicle 1 to travel.

The route generator 5 may output the optimal candidate route to the travel controller (not shown) that controls the travel of vehicle 1. The travel controller may output a route generation signal to the travel mechanism (not shown) to control travel according to the optimal candidate route. The travel mechanism includes, for example, an engine or motor that supplies power to vehicle 1, brakes that reduce the travel speed of vehicle 1, and a steering mechanism that steers vehicle 1.

The route generator 5 may output the optimal candidate route to an output device (not shown) that can present information to the driver of vehicle 1. The output device may include a display capable of displaying images or a speaker capable of playing sound. The output device may present information to the driver of vehicle 1 to enable travel according to the travel route. Vehicle 1 may further be equipped with input devices such as switches, touch panels, or microphones (not shown) to accept the driver's approval or rejection of the presented optimal candidate route.

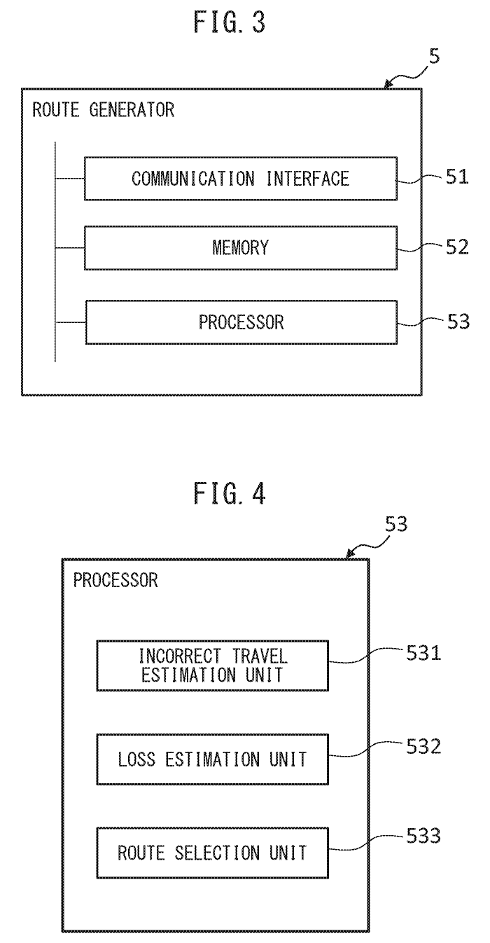

FIG. 3 is schematically illustrates a hardware of the route generator 5. The route generator 5 is a computer equipped with a communication interface 51, memory 52, and processor 53. The computer operates as the route generator 5 by executing the computer program for route generation stored in memory 52 with processor 53.

The communication interface 51 is an example of a communication unit and has a communication interface circuit for connecting the route generator 5 to the in-vehicle network. The communication interface 51 supplies the received data to processor 53. Additionally, the communication interface 51 outputs data supplied from processor 53 to the outside.

Memory 52 includes volatile semiconductor memory and non-volatile semiconductor memory. Memory 52 stores various data used in processing by processor 53, such as incorrect travel thresholds for estimating the possibility of incorrect travel at each branch point, candidate routes from the current position to the destination, and more than one parameter of a trained machine learning model for detecting geographical features from surrounding images. Additionally, memory 52 stores various application programs executed by processor 53, such as a computer program for route generation for executing route generation processing on processor 53.

Processor 53 is an example of a control unit and includes one or more processors and their peripheral circuits. Processor 53 may further include other arithmetic circuits such as a logic arithmetic unit, numerical arithmetic unit, or graphic processing unit.

FIG. 4 is a functional block diagram of processor 53 included in route generator 5.

Processor 53 of route generator 5 has functional blocks including an incorrect travel estimation unit 531, a loss estimation unit 532, and a route selection unit 533. Each of these units in processor 53 is a functional module implemented by programs executed on processor 53. The computer programs that realize the functions of each unit in processor 53 may be provided in a form recorded on computer-readable portable recording media such as semiconductor memory, magnetic recording media, or optical recording media. Alternatively, each of these units in processor 53 may be implemented in the route generator 5 as independent integrated circuits, microprocessors, or firmware.

The incorrect travel estimation unit 531 estimates the possibility of incorrect travel at more than one branch point included in the travel route from the current position to the destination DST for vehicle 1. A branch point is a location where multiple directions are possible, and it can be identified by referring to the map information stored in storage device 4. Incorrect travel corresponds to vehicle 1 proceeding in a direction different from the direction set as the travel route among multiple directions at a branch point.

The incorrect travel estimation unit 531 outputs a discrete value representing the possibility of incorrect travel (for example, "high possibility/low possibility") as the estimation result. The incorrect travel estimation unit 531 may output a continuous value representing the possibility of incorrect travel (for example, "0%-100%") as the estimation result.

The incorrect travel estimation unit 531 may estimate the possibility of incorrect travel using multiple estimation criteria. For example, the incorrect travel estimation unit 531 estimates the possibility of incorrect travel according to each of multiple estimation criteria and determines their statistical representative values (for example, maximum value, minimum value, arithmetic mean, median). The incorrect travel estimation unit 531 may output the determined statistical representative value as a continuous value indicating the possibility of incorrect travel at the branch point. Additionally, the incorrect travel estimation unit 531 may output information corresponding to "possibility exists" or "no possibility" depending on whether the determined statistical representative value exceeds a predetermined estimation threshold, as a discrete value indicating the possibility of incorrect travel at the branch point.

The incorrect travel estimation unit 531 may perform rule-based scoring as one of the multiple estimation criteria. Rule-based scoring may be an assessment of the possibility of incorrect travel at branch points based on map information stored in storage device 4.

The incorrect travel estimation unit 531 may estimate the possibility of incorrect travel according to the difficulty of the terrain, including branch points represented in the map information. Specifically, in complex terrains such as branch points that can branch in multiple directions, branch points arranged consecutively in relatively short sections, roundabouts, and terrains with repeated similar structures (airports, parking lots, etc.), the incorrect travel estimation unit 531 may highly estimate the possibility of incorrect travel.

The incorrect travel estimation unit 531 may estimate the possibility of incorrect travel at branch points by referring to the probability of incorrect travel for directions set as the travel route at branch points included in the map information. Specifically, the incorrect travel estimation unit 531 may estimate that the higher the probability of incorrect travel for directions set as the travel route at branch points included in the map information, the greater the possibility of incorrect travel at the branch point.

The incorrect travel estimation unit 531 may estimate the possibility of incorrect travel at branch points based on environmental information representing the travel environment of vehicle 1. Environmental information may be surrounding images generated by the surrounding camera representing the situation of forward branch points located ahead of vehicle 1. Processor 53 may be configured to input surrounding images into a trained machine learning model defined by parameters stored in memory 52 to detect features located ahead of vehicle 1. The trained machine learning model may be trained to output the confidence indicating the likelihood of detecting the feature along with the position of the area of the surrounding image corresponding to the feature, in response to the input of surrounding images. In this case, the incorrect travel estimation unit 531 may estimate that the lower the confidence of detection when detecting features in front of vehicle 1 from surrounding images, the greater the possibility of incorrect travel at forward branch points.

In situations where lane markings are not clearly detected, such as snowy roads, unpaved roads, and private properties, or in conditions where visibility is not sufficiently good, such as bad weather and nighttime, or when features around branch points are in the blind spots of surrounding objects like other vehicles, it becomes difficult to appropriately detect features from surrounding images. The incorrect travel estimation unit 531 may estimate the possibility of incorrect travel at branch points using information indicating that vehicle 1 is in these situations (such as attributes of the road being driven on in map information, time information, weather information, information on surrounding objects, etc.) as environmental information.

Environmental information may be positioning accuracy information output from GNSS receiver 3. In this case, the incorrect travel estimation unit 531 may estimate that the possibility of incorrect travel is high at branch points where the positioning accuracy is lower than a predetermined accuracy threshold stored in memory 52 among the branch points included in the travel route. The incorrect travel estimation unit 531 may estimate the possibility of incorrect travel based on positioning accuracy for branch points expected to be passed before a predetermined time (e.g., 1 minute) has elapsed since obtaining positioning accuracy information.

In road conditions such as where there are parallel roads or inside long tunnels, the positioning accuracy from GNSS signals decreases. The incorrect travel estimation unit 531 may estimate the possibility of incorrect travel at branch points using information indicating that vehicle 1 is in these situations (such as road structures included in map information) as environmental information.

In situations where the features detected from surrounding images do not correspond to those stored as map information, such as where only two lanes are detected from surrounding images while driving on a road indicated as three lanes in map information, it becomes impossible to appropriately place the vehicle's position on the map, increasing the possibility of incorrect travel. The incorrect travel estimation unit 531 may estimate the possibility of incorrect travel at branch points by comparing features detected from surrounding images with map information.

The incorrect travel estimation unit 531 may perform learning-based scoring as one of multiple estimation criteria. As learning-based scoring, the incorrect travel estimation unit 531 may estimate the possibility of incorrect travel using a trained machine learning model. The machine learning model may be trained using combinations of numerous set travel routes and actual travel routes from the past as training data. In the training data, a travel route on a road difficult to drive (narrow roads, dead ends, unpaved roads, etc.) may be considered incorrect. The machine learning model may be an existing machine learning model such as a decision tree or neural network.

The loss estimation unit 532 determines whether the possibility of incorrect travel at more than one branch point included in the travel route is estimated as higher than a predetermined incorrect travel threshold. If it is determined that the possibility of incorrect travel at more than one branch point is estimated as higher than the incorrect travel threshold, the loss estimation unit 532 generates multiple candidate routes from the current position to the destination DST. Then, the loss estimation unit 532 estimates the loss when driving each of the multiple candidate routes. At this time, the loss estimation unit 532 considers the possibility of incorrect travel at each branch point included in the candidate routes. That is, the loss of a candidate route is represented by the possibility of correct driving at branch points (i.e., 1 - possibility of incorrect travel) × loss when driving correctly + possibility of incorrect travel at branch points × loss when driving incorrectly.

Multiple candidate routes may be generated in advance. For example, processor 53 may generate multiple candidate routes and select a route from them according to predetermined selection criteria such as shortest required time, shortest driving distance, and minimum energy cost, as the travel route.

The loss estimation unit 532 can generate candidate routes using known algorithms (e.g., Dijkstra's method). The loss estimation unit 532 estimates the loss when driving candidate routes by referring to the loss caused by driving between adjacent points included in the map information stored in the storage device.

The loss estimation unit 532 may calculate the loss using multiple criteria. For example, the loss estimation unit 532 calculates the loss according to each of multiple criteria and determines their statistical representative values (e.g., total value, arithmetic mean).

The loss estimation unit 532 may estimate the loss based on time loss. For example, the loss estimation unit 532 estimates the loss based on time loss by multiplying the difference between the required time of the candidate route and the required time of the initial travel route by a predetermined time loss coefficient.

The loss estimation unit 532 may estimate the loss based on monetary loss. For example, the loss estimation unit 532 estimates the loss based on monetary loss by multiplying the difference between the energy cost required for driving the candidate route and the energy cost required for driving the initial route by a predetermined monetary loss coefficient.

The loss estimation unit 532 may estimate the loss based on comfort loss. Comfort loss is the loss corresponding to how comfortable driving the candidate route is compared to driving the initial route. For example, routes including difficult-to-drive points (narrow roads, dead ends, unpaved roads, etc.) are estimated to have high comfort loss. For example, the loss estimation unit 532 estimates the loss based on comfort loss according to the number of difficult-to-drive points in candidate routes identified by referring to the attributes of roads being driven in map information. Additionally, routes including avoidance points that were set as travel routes in the past but avoided by the driver are estimated to have higher comfort loss the more times those avoidance points were avoided. For example, the loss estimation unit 532 estimates the loss based on comfort loss according to the number of avoidance points in candidate routes identified by referring to past driving history.

Even at points with high loss, if they are points driven in the past, there is not a significant need to actively avoid them. For example, if it is a shortcut to home, there is no need to avoid even unpaved narrow roads. The loss estimation unit 532 may estimate the loss such that candidate routes passing through points with fewer driving occurrences have higher loss, and those passing through points with more driving occurrences have lower loss, based on the driving history of vehicle 1.

The route selection unit 533 selects the route with the minimum estimated loss among multiple candidate routes as the optimal candidate route.

The loss estimated by the loss estimation unit 532 does not necessarily correspond to the selection criteria for choosing a travel route from multiple candidate routes. Even if the loss estimated by the loss estimation unit 532 corresponds to the selection criteria, the estimation of loss by the loss estimation unit 532 considers the possibility of incorrect travel at branch points. Therefore, the optimal candidate route selected by the route selection unit 533 does not necessarily match the travel route.

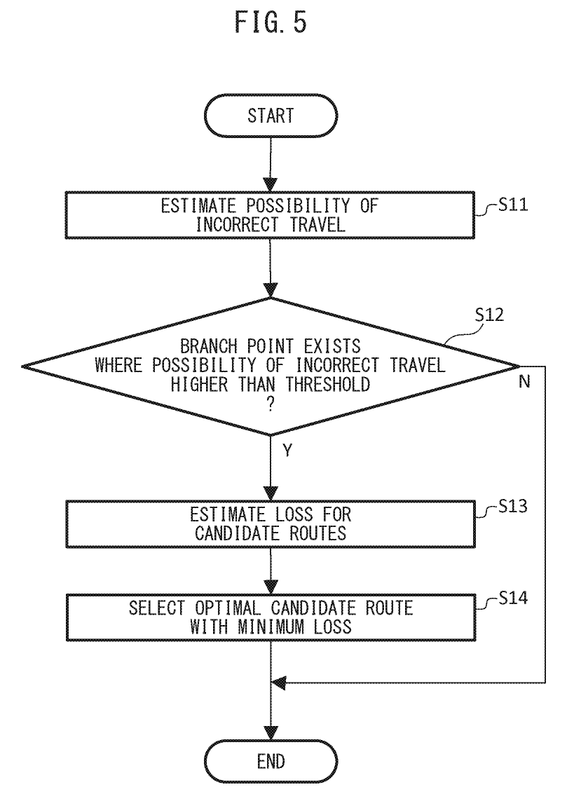

FIG. 5 is a flowchart of the route generation process. The route generator 5 executes the process shown in FIG. 5 at predetermined intervals (e.g., every 100ms) while vehicle 1 is driving. Additionally, the route generator 5 may execute the process shown in FIG. 5 each time a branch point is passed.

First, the incorrect travel estimation unit 531 of processor 53 in the route generator 5 estimates the possibility of incorrect travel at more than one branch point included in the travel route from the current position to the destination (Step S11).

Next, the loss estimation unit 532 of processor 53 determines whether there is more than one branch point in the travel route where the possibility of incorrect travel is higher than the incorrect travel threshold (Step S12).

If it is determined that there are no branch points in the travel route where the possibility of incorrect travel is higher than the incorrect travel threshold (Step S12:N), the loss estimation unit 532 of processor 53 ends the route generation process.

If it is determined that there is more than one branch point where the possibility of incorrect travel is higher than the incorrect travel threshold (Step S12:Y), the loss estimation unit 532 estimates the loss for each of the multiple candidate routes from the current location to the destination when traveling on the candidate route (Step S13).

Then, the route selection unit 533 of the processor 53 selects the route with the minimum estimated loss among the multiple candidate routes as the optimal candidate route and completes the route generation process.

By executing the route generation process in this way, the route generator 5 can generate a travel route in consideration of the travel cost in the event of incorrect travel.

It should be noted that those skilled in the art can apply various changes, substitutions, and modifications without departing from the spirit and scope of the present disclosure.

What is claimed is:

1. A route generator comprising a processor configured to:
estimate a possibility of incorrect travel in which a vehicle proceeds in a direction different from a direction set as a travel route among multiple directions at more than one of branch points included in the travel route from a current position to a destination,
estimate a loss based on at least one of time, money, and comfort when traveling each of a plurality of candidate routes from the current position to the destination if the possibility of incorrect travel at more than one of the branch points is estimated to be higher than a predetermined incorrect travel threshold, and
select a route with minimum estimated loss among the plurality of candidate routes as an optimal candidate route.

2. The route generator according to claim 1, wherein, in the estimation of the possibility of the incorrect travel, estimating the possibility of incorrect travel based on at least one of map information including the incorrect travel rate for each of the multiple directions at each branch point and environmental information representing the travel environment of the vehicle.

3. The route generator according to claim 2, wherein, in the estimation of the possibility of the incorrect travel, estimating that, the higher the incorrect travel rate for the direction set as the travel route at the branch point in the travel route contained in the map information, the greater the possibility of incorrect travel at that branch point in the travel route.

4. The route generator according to claim 2, wherein
the environmental information includes a surrounding image representing a situation of a forward branch point located ahead of the vehicle, and
in the estimation of the possibility of the incorrect travel, estimating that, the lower the detection confidence when detecting a forward feature by inputting the surrounding image into a machine learning model trained to detect a predetermined feature, the greater the possibility of incorrect travel at the forward branch point.

5. The route generator according to claim 2, wherein
the environmental information includes a positioning accuracy of the vehicle, and
in the estimation of the possibility of the incorrect travel, estimating that, at a branch point where the positioning accuracy is lower than a predetermined accuracy threshold among more than one of the branch points included in the travel route, the possibility of incorrect travel is higher than that with higher positioning accuracy than the predetermined accuracy threshold.

6. A vehicle including a travel controller configured to controls the vehicle so as to travel in accordance with the optimal candidate route selected by the route generator according claim 1.

7. A method for generating route comprising:
estimating a possibility of incorrect travel in which a vehicle proceeds in a direction different from a direction set as a travel route among multiple directions at more than one of branch points included in the travel route from a current position to a destination,
estimating a loss based on at least one of time, money, and comfort when traveling each of a plurality of candidate routes from the current position to the destination if the possibility of incorrect travel at more than one of the branch points is estimated to be higher than a predetermined incorrect travel threshold, and
selecting a route with minimum estimated loss among the plurality of candidate routes as an optimal candidate route.
